(19) United States
(12) Patent Application Publication
(10) Pub. No.: US 2026/0072054 A1
(43) Pub. Date: Mar. 12, 2026

(54) ROTATIONAL SPEED DETECTION STRUCTURE OF ACTUATOR AND ACTUATOR

(71) Applicant: Fourier Intelligence Inc., Shanghai (CN)

(72) Inventors: Xuegang ZHONG, Shanghai (CN); Hanyu XIA, Shanghai (CN)

(73) Assignee: Fourier Intelligence Inc., Shanghai (CN)

(21) Appl. No.: 19/308,382

(22) Filed: Aug. 25, 2025

Related U.S. Application Data
(63) Continuation of application No. PCT/CN2025/103288, filed on Jun. 25, 2025.

(30) Foreign Application Priority Data
Sep. 12, 2024 (CN) 202411275903.0

(51) Int. Cl. G01P 3/487; B25J 13/08; G01D 5/14

(52) U.S. Cl. CPC G01P 3/487; B25J 13/088; G01D 5/145

(57) ABSTRACT

The provided is a rotational speed detection structure of an actuator and an actuator. The rotational speed detection structure of an actuator includes an outer housing, a motor, and a reducer mechanism, where the motor includes a stator and a rotor; a shaft sleeve is connected to the rotor; the reducer mechanism includes an input end connected to the rotor, and an output end connected to an encoder shaft; a first mounting surface is disposed on the encoder shaft; a second mounting surface is disposed on the shaft sleeve; a first magnetic ring is fixed on the first mounting surface; a second magnetic ring is fixed on the second mounting surface; a printed circuit board (PCB) is fixed on the outer housing; the PCB includes a third mounting surface; a first Hall element and a second Hall element are provided on the third mounting surface.

### CROSS-REFERENCE TO THE RELATED APPLICATIONS

This application is a continuation application of International Application No. PCT/CN2025/103288, filed on June 25, 2025, which is based upon and claims priority to Chinese Patent Application No. 202411275903.0, filed on September 12, 2024, the entire contents of which are incorporated herein by reference.

### TECHNICAL FIELD

The present disclosure relates to the technical field of robot actuation and in particular to a rotational speed detection structure of an actuator and an actuator.

### BACKGROUND

As a central component of the robot joint, the actuator is configured to provide power for a relative motion between two moving components of the robot joint, and accurately control movement angles of the two moving components in the robot joint. In order that the robot joint can accurately execute relevant instructions, a detection structure is typically provided in the actuator to detect angles of relevant components in the actuator, particularly angles of output ends. A motor and a reducer mechanism are usually provided in the actuator. The reducer mechanism is configured to transfer an output power of the motor to the output end of the actuator. To control the angles of the output ends, the output end (the high-speed end of the actuator) of the motor and the output end (the low-speed end) of the actuator each are provided with a rotational angle detection unit. For actuators in the prior art, the detection unit at the high-speed end and the detection unit at the low-speed end are dependent of each other, occupying large spaces in the actuators, and affecting miniaturization of the actuators.

### SUMMARY

An objective of the present disclosure is to provide a rotational speed detection structure of an actuator and an actuator, to solve problems of a low integrated level and a large occupied space for the detection unit at the high-speed end and the detection unit at the low-speed end in the prior art.

The objective of the present disclosure is achieved through the following technical solutions:

A rotational speed detection structure of an actuator includes an outer housing, a motor, and a reducer mechanism, where

the motor includes a stator fixedly fitted to the outer housing, and a rotor matching with the stator and rotatable relative to the stator; a shaft sleeve pivotally fitted to the outer housing is synchronously connected to the rotor; and the reducer mechanism includes an input end connected to the rotor, and an output end connected to an encoder shaft extending through the shaft sleeve and coaxial with the shaft sleeve;

a first mounting surface is disposed on the encoder shaft; a second mounting surface is disposed on the shaft sleeve; in a radial direction of the actuator, the second mounting surface is located outside the first mounting surface; a first magnetic ring is fixed on the first mounting surface; a second magnetic ring is fixed on the second mounting surface; central axes of both the first magnetic ring and the second magnetic ring coincide with a central axis of the encoder shaft; a printed circuit board (PCB) is fixed on the outer housing; the PCB includes a third mounting surface directly facing the first mounting surface and the second mounting surface; a first Hall element and a second Hall element are provided on the third mounting surface; the first Hall element cooperates with the first magnetic ring to detect a rotational angle of the first magnetic ring, so as to obtain an angle of the encoder shaft; and the second Hall element cooperates with the second magnetic ring to detect a rotational angle of the second magnetic ring, so as to obtain an angle of the shaft sleeve; and alternatively, the first Hall element cooperates with the first magnetic ring to detect a rotational speed of the first magnetic ring, so as to obtain an angular speed of the encoder shaft; and the second Hall element cooperates with the second magnetic ring to detect a rotational speed of the second magnetic ring, so as to obtain an angular speed of the shaft sleeve.

the first Hall element cooperates with the first magnetic ring to detect a rotational speed of the first magnetic ring, so as to obtain an angular speed of the encoder shaft; and the second Hall element cooperates with the second magnetic ring to detect a rotational speed of the second magnetic ring, so as to obtain an angular speed of the shaft sleeve.

According to the rotational speed detection structure of an actuator provided by the embodiment of the present disclosure, since the first mounting surface for providing the first magnetic ring and the second mounting surface for providing the second magnetic ring are respectively disposed on the encoder shaft and the shaft sleeve that are sleeved to each other, the first magnetic ring and the second magnetic ring can be located at a same position or an approximately same position in an axial direction of the actuator. By disposing one PCB on the outer housing only, two Hall elements respectively matching with two magnetic rings can be provided. That is, Hall elements corresponding to the two magnetic rings share the same PCB, simplifying an internal structure of the actuator, improving an integrated level in the actuator, and facilitating optimization on an internal space of the actuator. In addition, detection at a low-speed end of the actuator and detection at a high-speed end of the actuator are integrated to a same region in the actuator, which can facilitate internal trace arrangement.

In a preferred embodiment, a first annular support is detachably fixed on the encoder shaft; a second annular support surrounding the first annular support is detachably fixed on the shaft sleeve; a top surface of the first annular support forms the first mounting surface; and a top surface of the second annular support forms the second mounting surface. The first annular support and the second annular support are detachably fixed on the encoder shaft and the shaft sleeve, respectively. By respectively disposing the first magnetic ring and the second magnetic ring on the first annular support and the second annular support, assembly and maintenance of the actuator are convenient.

In a preferred embodiment, a downward-depressed first annular groove is formed in the top surface of the first annular support; a thickness of the first magnetic ring is the same as a depth of the first annular groove, and the first magnetic ring is nested in the first annular groove; a downward-depressed second annular groove is formed in the top surface of the second annular support; a thickness of the second magnetic ring is the same as a depth of the second annular groove, and the second magnetic ring is nested in the second annular groove; and an upper surface of the first magnetic ring is flush with an upper surface of the second magnetic ring. Since the first magnetic ring and the second magnetic ring are respectively provided on the top surface of the first annular support and the top surface of the second annular support in a sinking manner, such that the first annular support and the second annular support have a relatively small gap with the PCB. Meanwhile, the two magnetic rings are staggered to each other in the radial direction of the actuator, and the upper surfaces of the two magnetic rings are flush to each other in the axial direction of the actuator, further reducing a space occupied by the whole rotational speed detection structure in the axial direction of the actuator.

In a preferred embodiment, a fixed seat is sleeved on the encoder shaft; a set screw is threadedly connected to the fixed seat; an inner end of the set screw is inserted into a screw hole formed in the encoder shaft; and the first annular support is sleeved on the fixed seat and is in thread fit with the fixed seat. The fixed seat is disposed on the encoder shaft, such that a portion for providing the first annular support on the encoder shaft has a relatively large outer diameter. After a diameter of the encoder shaft less than a diameter of the shaft sleeve is increased through the fixed seat, the first annular support can get close to the second annular support as much as possible in the radial direction of the actuator. Consequently, the first mounting surface is closer to the second mounting surface, and there is a relatively small spacing distance between the first magnetic ring and the second magnetic ring in the radial direction of the actuator. The two Hall elements can be provided only with the small-size PCB, which can further reduce a space occupied by the PCB, and facilitate optimization on the internal space of the actuator. The first magnetic ring and the first annular support are formed into an assembly, and the assembly is threadedly connected to the encoder shaft, such that the actuator is assembled simply and conveniently.

In a preferred embodiment, the second annular support is sleeved on a top of the shaft sleeve and is in thread fit with the shaft sleeve.

In a preferred embodiment, the outer housing includes an outer sidewall, a top wall extending inward along the radial direction of the actuator from a top of the outer sidewall, and a supporting wall extending downward from an inner edge of the top wall; a mounting space is formed between the supporting wall and the outer sidewall; the motor is disposed in the mounting space; the stator is fixedly connected to a periphery of the supporting wall; the rotor surrounds the stator; and the PCB is fixedly connected to the top wall, such that the PCB is located above the first mounting surface and the second mounting surface. With the outer sidewall, the top wall and the supporting wall, the outer housing forms a structure with a U-shaped cross section, providing the mounting space for the motor, and protecting the motor well. Meanwhile, the top wall provides a mounting foundation for the PCB, facilitating mounting of the PCB.

In a preferred embodiment, a mounting disc is fixedly connected on the top wall; an upward protruding annular convex rib is disposed on an upper surface of the mounting disc; and an outer edge of the PCB is circular and abuts against an inner edge of the annular convex rib. The annular convex rib is used to locate the PCB in the radial direction of the actuator, such that the two Hall elements preassembled on the PCB can be respectively aligned at the two magnetic rings in the radial direction of the actuator. While improving mounting accuracy of the PCB, this ensures that rotational speed detection at the low-speed end and the high-speed end of the actuator achieves desirable accuracy.

In a preferred embodiment, the reducer mechanism is a harmonic reducer; a steel wheel of the harmonic reducer is fixedly fitted to the outer housing; a wave generator of the harmonic reducer is connected to a bottom of the rotor through a connecting bracket; an output flange pivotally connected to the outer housing through a bearing is fixed on a flexible wheel of the harmonic reducer; a bottom of the encoder shaft is fixedly connected to the output flange; a fixed bracket is fixedly connected on the top wall; and a top of the encoder shaft is pivotally connected to the fixed bracket through a bearing. Upper and lower ends of the encoder shaft are pivotally fitted to the outer housing through the bearings. The bearings serve to radially support the encoder shaft, such that the encoder shaft rotates more stably, improving accuracy of the rotational speed detection at the low-speed end.

In a preferred embodiment, a lower end of the shaft sleeve is fixedly connected to the connecting bracket through a bolt, such that the shaft sleeve and the rotor are synchronously connected; and the shaft sleeve is located at an inner side of the supporting wall and pivotally fitted to the supporting wall through a bearing. The supporting wall and the bearing serve to radially support the shaft sleeve, such that the shaft sleeve rotates more stably, improving accuracy of the rotational speed detection at the high-speed end.

An actuator includes the rotational speed detection structure of an actuator.

### BRIEF DESCRIPTION OF THE DRAWINGS

FIG. 1 is a schematic structural view according to the present disclosure;

FIG. 2 is a sectional view according to the present disclosure

FIG. 3 is an enlarged view of A shown in FIG. 2;

FIG. 4 is a schematic assembly view of two magnetic rings with a first annular support and a second annular support in FIG. 2; and

FIG. 5 is a schematic structural view of a mounting disc in FIG. 2.

### DETAILED DESCRIPTION OF THE EMBODIMENTS

The present disclosure is further described below in combination with the accompanying drawings and specific implementations.

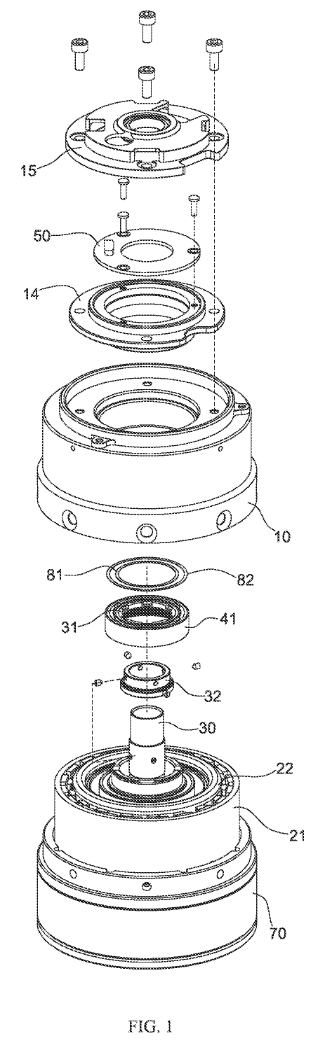

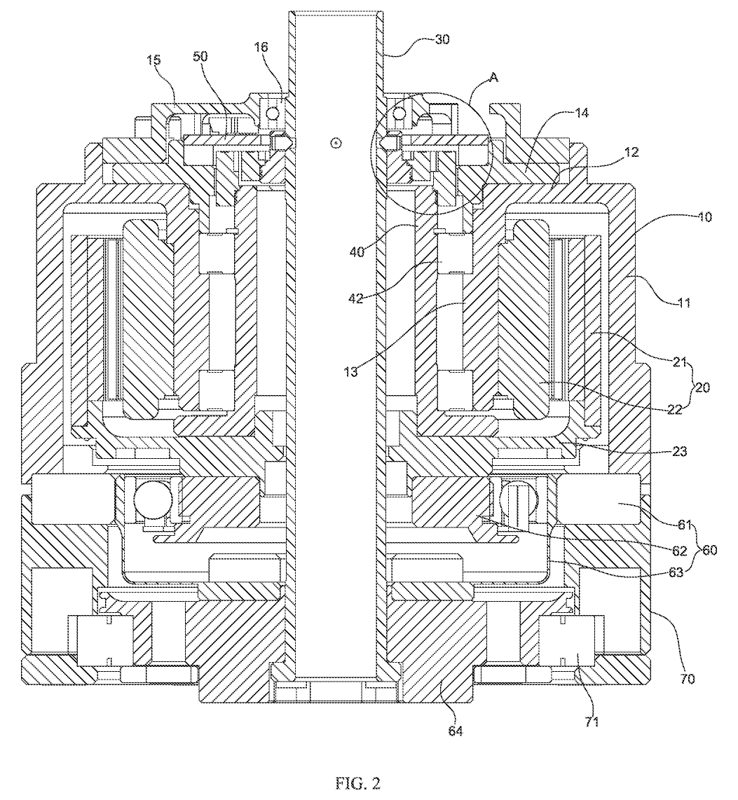

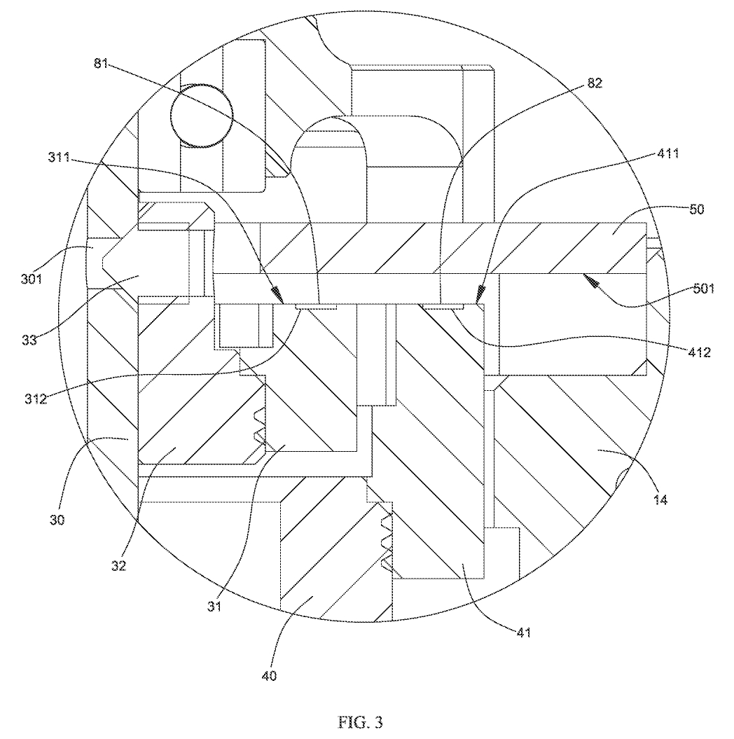

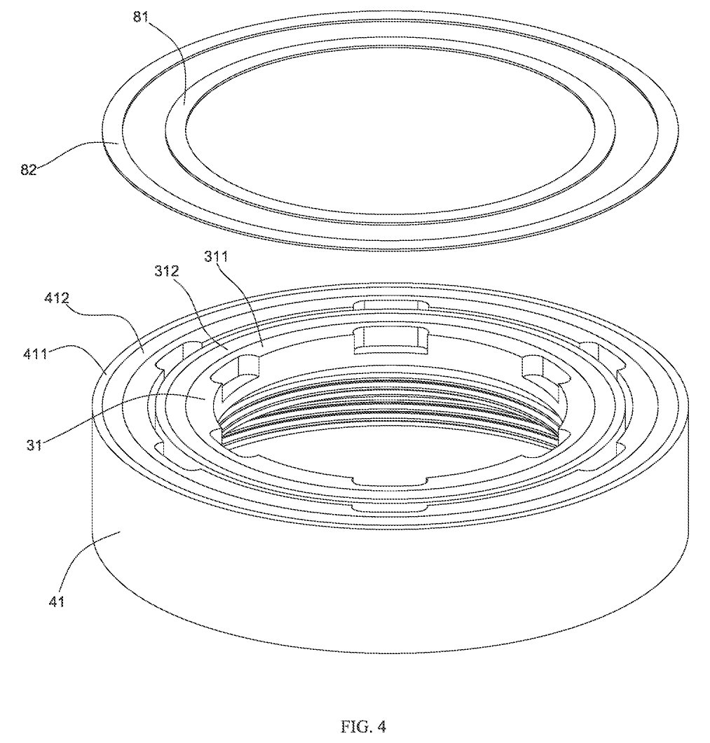

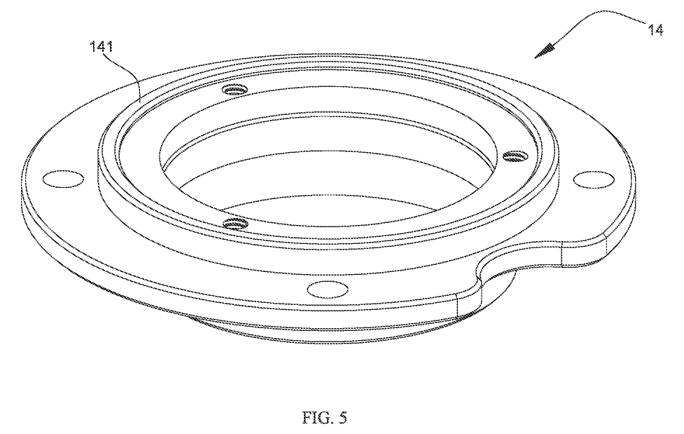

Referring to FIGS. 1-5, the present disclosure provides a rotational speed detection structure of an actuator, including outer housing 10, motor 20, and a reducer mechanism. The motor 20 and the reducer mechanism are provided in the outer housing 10. The reducer mechanism is harmonic reducer 60. The motor 20 includes stator 22 and rotor 21. The stator 22 is fixedly fitted to the outer housing 10. The rotor 21 surrounds the stator 22 and matches with the stator 22. Thus, the rotor 21 and the stator 22 form a frameless torque motor. Shaft sleeve 40 is synchronously connected to the rotor 21. An input end of the harmonic reducer 60 is connected to the rotor 21. That is, wave generator 62 of the harmonic reducer 60 is connected to the rotor 21. Flexible wheel 63 of the harmonic reducer 60 serves as an output end to which encoder shaft 30 is connected. The encoder shaft 30 extends through the shaft sleeve 40 and is coaxial with the shaft sleeve 40. The encoder shaft 30 is pivotally fitted to the outer housing 10. The encoder shaft 30 extends through a whole axial direction of an actuator upward from a lower end of the actuator to a top of the actuator. First mounting surface 311 is disposed on the encoder shaft 30. Second mounting surface 411 is disposed on the shaft sleeve 40. First magnetic ring 81 is fixedly connected to the first mounting surface 311. Second magnetic ring 82 is fixedly connected to the second mounting surface 411. The first magnetic ring 81 and the second magnetic ring 82 are located at a same height or nearly located at the same height. Central axes of both the first magnetic ring 81 and the second magnetic ring 82 coincide with a central axis of the encoder shaft 30. PCB 50 is fixed on the outer housing 10. The PCB 50 includes third mounting surface 501 directly facing the first mounting surface 311 and the second mounting surface 411. A first Hall element and a second Hall element are provided on the third mounting surface 501. The first Hall element matches with the first magnetic ring 81. Through cooperation between the first Hall element and the first magnetic ring 81, a rotational angle of the first magnetic ring 81 is detected to obtain an angle of the encoder shaft 30, thereby obtaining an angle of an output end (namely a low-speed end) of the actuator. The second Hall element matches with the second magnetic ring 82. Through cooperation between the second Hall element and the second magnetic ring 82, a rotational angle of the second magnetic ring 82 is detected to obtain an angle of the shaft sleeve 40, thereby obtaining an angle of the rotor 21 (namely a high-speed end) of the motor 20.

With the first Hall element and the first magnetic ring 81 as an example, the first Hall element detects a change of a magnetic field when the first magnetic ring 81 rotates and calculates angular information, thereby obtaining an absolute angle of the first magnetic ring in rotation. The Hall element typically detects an angular speed of the magnetic ring with a pulse counting method: ω=2πf/N (ω is the angular speed, f is a pulse frequency, and N is a number of pole pairs of the magnetic ring), and then calculates the absolute angle of the magnetic ring in the rotation with the angular speed. The Hall element cooperates with the magnetic ring to obtain the angle, angular speed and other parameters of the magnetic ring in rotation, which is known to those skilled in the art, and is not described in detail herein.

In other embodiments, through the cooperation between the first Hall element and the first magnetic ring 81, a rotational speed of the first magnetic ring 81 may also be detected to obtain an angular speed of the encoder shaft 30, thereby obtaining an angle or an angular speed of the low-speed end. Through the cooperation between the second Hall element and the second magnetic ring 82, a rotational speed of the second magnetic ring 82 may also be detected to obtain an angular speed of the shaft sleeve 40, thereby obtaining an angle or an angular speed of the rotor 21 (namely the high-speed end) of the motor 20.

Since the first mounting surface 311 for providing the first magnetic ring 81 and the second mounting surface 411 for providing the second magnetic ring 82 are respectively disposed on the encoder shaft 30 and the shaft sleeve 40 that are sleeved to each other, the first magnetic ring 81 and the second magnetic ring 82 can be located at a same position or an approximately same position in the axial direction of the actuator. By disposing one PCB 50 on the outer housing 10 only, two Hall elements respectively matching with two magnetic rings can be provided. That is, Hall elements corresponding to the two magnetic rings share the same PCB, simplifying an internal structure of the actuator, improving an integrated level in the actuator, and facilitating optimization on an internal space of the actuator. In addition, detection at the low-speed end of the actuator and detection at the high-speed end of the actuator are integrated to a same region in the actuator, which can facilitate internal trace arrangement.

The reducer mechanism in the present disclosure is not limited to the harmonic reducer 60. The reducer mechanism may further be a planetary reducer or a rotary vector (RV) reducer. The motor 20 may also be a frameless torque motor with a built-in rotor or a motor of other structures.

First annular support 31 is detachably fixed on the encoder shaft 30. Second annular support 41 surrounding the first annular support 31 is detachably fixed on the shaft sleeve 40. A top surface of the first annular support 31 forms the first mounting surface 311. A top surface of the second annular support 41 forms the second mounting surface 411. In the preferred embodiment, the first annular support 31 and the second annular support 41 are detachably fixed on the encoder shaft 30 and the shaft sleeve 40, respectively. By respectively disposing the first magnetic ring 81 and the second magnetic ring 82 on the first annular support 31 and the second annular support 41, assembly and maintenance of the actuator are convenient.

In addition, fixed seat 32 is further sleeved on the encoder shaft 30. Set screw 33 is threadedly connected to the fixed seat 32. The set screw 33 extends along a radial direction of the encoder shaft 30, with an inner end inserted into a screw hole formed in the encoder shaft 30. An outer thread is disposed at an outer circumferential edge of the fixed seat 32. An inner edge of the first annular support 31 is provided with an inner thread. Through cooperation between the inner thread and the outer thread, the first annular support 31 is fixed at a periphery of the fixed seat 32. The fixed seat 32 is disposed on the encoder shaft 30, such that a portion for providing the first annular support 31 on the encoder shaft 30 has a relatively large outer diameter. After a diameter of the encoder shaft 30 less than a diameter of the shaft sleeve 40 is increased through the fixed seat 32, the first annular support 31 can get close to the second annular support 41 as much as possible in the radial direction of the actuator. Consequently, the first mounting surface 311 is closer to the second mounting surface 411, and there is a relatively small spacing distance between the first magnetic ring 81 and the second magnetic ring 82 in the radial direction of the actuator. The two Hall elements can be provided only with the small-size PCB 50, which can further reduce a space occupied by the PCB 50, and facilitate optimization on the internal space of the actuator.

The second annular support 41 may also be fixed on the shaft sleeve 40 in thread fit. Specifically, an outer thread is disposed on a top of an outer edge surface of the shaft sleeve 40. An inner thread is disposed at an inner edge of the second annular support 41. Through cooperation between the inner thread and the outer thread, the second annular support 41 is threadedly connected to a top of the shaft sleeve 40. In the present disclosure, the first annular support 31 is threadedly and detachably fixed on the encoder shaft 30 or the fixed seat 32 of the encoder shaft 30. The second annular support 41 is threadedly and detachably fixed on the shaft sleeve 40. In assembly, the first magnetic ring 81 and the first annular support 31 are formed into an assembly, and the second magnetic ring 82 and the second annular support 41 are formed into an assembly. Two assemblies are disposed on the encoder shaft 30 and the shaft sleeve 40 of the actuator from top to bottom. The PCB 50 with the two Hall elements covers the first annular support 31 and the second annular support 41, ensuring that the two Hall elements respectively correspond to the two magnetic rings. In this way, the actuator is assembled simply and conveniently.

In order to further optimize an axial space of the actuator, downward-depressed first annular groove 312 is formed in the top surface of the first annular support 31. The first magnetic ring 81 is nested in the first annular groove 312. A thickness of the first magnetic ring 81 is the same as a depth of the first annular groove 312, such that the first magnetic ring 81 does not protrude from the top surface of the first annular support 31. Likewise, downward-depressed second annular groove 412 is formed in the top surface of the second annular support 41. The second magnetic ring 82 is nested in the second annular groove 412. A thickness of the second magnetic ring 82 is the same as a depth of the second annular groove 412, such that the second magnetic ring 82 does not protrude from the top surface of the second annular support 41. The top surface of the first annular support 31 is flush with the top surface of the second annular support 41. With the above structure, an upper surface of the first magnetic ring 81 is flush with an upper surface of the second magnetic ring 82. Since the first magnetic ring 81 and the second magnetic ring 82 are respectively provided on the top surface of the first annular support 31 and the top surface of the second annular support 41 in a sinking manner, such that the first annular support 31 and the second annular support 41 have a relatively small gap with the PCB 50. Meanwhile, the two magnetic rings are staggered to each other in the radial direction of the actuator, and the upper surfaces of the two magnetic rings are flush to each other in the axial direction of the actuator, further reducing a space occupied by the whole rotational speed detection structure in the axial direction of the actuator.

It is particularly to be noted that the first mounting surface 311 may also be directly disposed on the encoder shaft 30, and the second mounting surface 411 may also be directly disposed on the shaft sleeve 40.

The outer housing 10 includes outer sidewall 11, top wall 12, and supporting wall 13. The top wall 12 extends inward along the radial direction of the actuator from a top of the outer sidewall 11. The supporting wall 13 extends downward from an inner edge of the top wall 12. A mounting space is formed between the supporting wall 13 and the outer sidewall 11. The motor 20 is disposed in the mounting space. The stator 22 of the motor 20 is fixedly sleeved on the supporting wall 13. The rotor 21 is disposed between the stator 22 and the outer wall 11 and around the stator 22. The PCB 50 is fixedly connected to the top wall 12, such that the PCB 50 is fixed on the outer housing 10 and located above the first mounting surface 311 and the second mounting surface 411. With the outer sidewall 11, the top wall 12 and the supporting wall 13, the outer housing 10 forms a structure with a U-shaped cross section, providing the mounting space for the motor 20, and protecting the motor 20 well. Meanwhile, the top wall 12 provides a mounting foundation for the PCB 50, facilitating mounting of the PCB 50.

In order to further improve convenience in mounting, mounting disc 14 is fixedly connected on the top wall 12. Upward protruding annular convex rib 141 is disposed on an upper surface of the mounting disc 14. An outer edge of the PCB 50 is circular. The PCB 50 is placed on the upper surface of the mounting disc 14, with the outer edge abutting against an inner edge of the annular convex rib 141. The annular convex rib 141 is used to locate the PCB 50 in the radial direction of the actuator, such that the two Hall elements preassembled on the PCB 50 can be respectively aligned at the two magnetic rings in the radial direction of the actuator. While improving mounting accuracy of the PCB 50, this ensures that rotational speed detection at the low-speed end and the high-speed end of the actuator achieves desirable accuracy.

The harmonic reducer 60 includes the wave generator 62, the steel wheel 61, and the flexible wheel 63. The steel wheel 61 is fixedly fitted to the outer housing 10. The wave generator 62 is connected to a bottom of the rotor 21 through connecting bracket 23. Output flange 64 is fixed on the flexible wheel 63. The output flange 64 is pivotally connected through bearing 71 to lower housing 70 fixedly connected to the outer housing 10. The steel wheel 61 may be clamped and fixed between the lower housing 70 and the outer housing 10, such that the steel wheel 61 is fixedly fitted to the outer housing 10. A bottom of the encoder shaft 30 is fixedly connected to the output flange 64 through a bolt. Fixed bracket 15 is fixedly connected on the top wall 12. A top of the encoder shaft 30 is pivotally connected to the fixed bracket 15 through bearing 16. Thus, upper and lower ends of the encoder shaft 30 are pivotally fitted to the outer housing 10 through the bearing 16 and the bearing 71, respectively. The bearing 16 and the bearing 71 serve to radially support the encoder shaft 30, such that the encoder shaft 30 rotates more stably, improving accuracy of the rotational speed detection at the low-speed end.

A lower end of the shaft sleeve 40 is fixedly connected to the connecting bracket 23 through a bolt, such that the shaft sleeve 40 and the rotor 21 are synchronously connected together. The shaft sleeve 40 is located at an inner side of the supporting wall 13. The shaft sleeve 40 is pivotally fitted to the supporting wall 13 through bearing 42. The supporting wall 13 and the bearing 42 serve to radially support the shaft sleeve 40, such that the shaft sleeve 40 rotates more stably, improving accuracy of the rotational speed detection at the high-speed end.

The present disclosure provides an actuator, including the rotational speed detection structure of an actuator. Other structures of the actuator are the same as those of the prior art, and are not described in detail herein.

What is claimed is:

1. A rotational speed detection structure of an actuator, comprising: an outer housing, a motor, and a reducer mechanism, wherein
the motor comprises a stator fixedly fitted to the outer housing, and a rotor matching with the stator and rotatable relative to the stator; a shaft sleeve pivotally fitted to the outer housing is synchronously connected to the rotor; and the reducer mechanism comprises an input end connected to the rotor, and an output end connected to an encoder shaft extending through the shaft sleeve and coaxial with the shaft sleeve; and
a first mounting surface is disposed on the encoder shaft; a second mounting surface is disposed on the shaft sleeve; in a radial direction of the actuator, the second mounting surface is located outside the first mounting surface; a first magnetic ring is fixed on the first mounting surface; a second magnetic ring is fixed on the second mounting surface; central axes of both the first magnetic ring and the second magnetic ring coincide with a central axis of the encoder shaft; a printed circuit board (PCB) is fixed on the outer housing; the PCB comprises a third mounting surface directly facing the first mounting surface and the second mounting surface; a first Hall element and a second Hall element are provided on the third mounting surface; the first Hall element cooperates with the first magnetic ring to detect a rotational angle of the first magnetic ring to obtain an angle of the encoder shaft; and the second Hall element cooperates with the second magnetic ring to detect a rotational angle of the second magnetic ring to obtain an angle of the shaft sleeve.

2. A rotational speed detection structure of an actuator, comprising: an outer housing, a motor, and a reducer mechanism, wherein
the motor comprises a stator fixedly fitted to the outer housing, and a rotor matching with the stator and rotatable relative to the stator; a shaft sleeve pivotally fitted to the outer housing is synchronously connected to the rotor; and the reducer mechanism comprises an input end connected to the rotor, and an output end connected to an encoder shaft extending through the shaft sleeve and coaxial with the shaft sleeve; and
a first mounting surface is disposed on the encoder shaft; a second mounting surface is disposed on the shaft sleeve; in a radial direction of the actuator, the second mounting surface is located outside the first mounting surface; a first magnetic ring is fixed on the first mounting surface; a second magnetic ring is fixed on the second mounting surface; central axes of both the first magnetic ring and the second magnetic ring coincide with a central axis of the encoder shaft; a PCB is fixed on the outer housing; the PCB comprises a third mounting surface directly facing the first mounting surface and the second mounting surface; a first Hall element and a second Hall element are provided on the third mounting surface; the first Hall element cooperates with the first magnetic ring to detect a rotational speed of the first magnetic ring to obtain an angular speed of the encoder shaft; and the second Hall element cooperates with the second magnetic ring to detect a rotational speed of the second magnetic ring to obtain an angular speed of the shaft sleeve.

3. The rotational speed detection structure of the actuator according to claim 1, wherein a first annular support is detachably fixed on the encoder shaft; a second annular support surrounding the first annular support is detachably fixed on the shaft sleeve; a top surface of the first annular support forms the first mounting surface; and a top surface of the second annular support forms the second mounting surface.

4. The rotational speed detection structure of the actuator according to claim 3, wherein a downward-depressed first annular groove is formed in the top surface of the first annular support; a thickness of the first magnetic ring is the same as a depth of the downward-depressed first annular groove, and the first magnetic ring is nested in the downward-depressed first annular groove; a downward-depressed second annular groove is formed in the top surface of the second annular support; a thickness of the second magnetic ring is the same as a depth of the downward-depressed second annular groove, and the second magnetic ring is nested in the downward-depressed second annular groove; and an upper surface of the first magnetic ring is flush with an upper surface of the second magnetic ring.

5. The rotational speed detection structure of the actuator according to claim 3, wherein a fixed seat is sleeved on the encoder shaft; a set screw is threadedly connected to the fixed seat; an inner end of the set screw is inserted into a screw hole formed in the encoder shaft; and the first annular support is sleeved on the fixed seat and is in thread fit with the fixed seat.

6. The rotational speed detection structure of the actuator according to claim 3, wherein the second annular support is sleeved on a top of the shaft sleeve and is in thread fit with the shaft sleeve.

7. The rotational speed detection structure of the actuator according to claim 1, wherein the outer housing comprises an outer sidewall, a top wall extending inward along the radial direction of the actuator from a top of the outer sidewall, and a supporting wall extending downward from an inner edge of the top wall; a mounting space is formed between the supporting wall and the outer sidewall; the motor is disposed in the mounting space; the stator is fixedly connected to a periphery of the supporting wall; the rotor surrounds the stator; and the PCB is fixedly connected to the top wall, wherein the PCB is located above the first mounting surface and the second mounting surface.

8. The rotational speed detection structure of the actuator according to claim 7, wherein a mounting disc is fixedly connected on the top wall; an upward protruding annular convex rib is disposed on an upper surface of the mounting disc; and an outer edge of the PCB is circular and abuts against an inner edge of the upward protruding annular convex rib.

9. The rotational speed detection structure of the actuator according to claim 7, wherein the reducer mechanism is a harmonic reducer; a steel wheel of the harmonic reducer is fixedly fitted to the outer housing; a wave generator of the harmonic reducer is connected to a bottom of the rotor through a connecting bracket; an output flange pivotally connected to the outer housing through a first bearing is fixed on a flexible wheel of the harmonic reducer; a bottom of the encoder shaft is fixedly connected to the output flange; a fixed bracket is fixedly connected on the top wall; and a top of the encoder shaft is pivotally connected to the fixed bracket through a second bearing.

10. The rotational speed detection structure of the actuator according to claim 9, wherein a lower end of the shaft sleeve is fixedly connected to the connecting bracket through a bolt, wherein the shaft sleeve and the rotor are synchronously connected; and the shaft sleeve is located at an inner side of the supporting wall and pivotally fitted to the supporting wall through a third bearing.

11. An actuator, comprising: the rotational speed detection structure of the actuator according to claim 1.

12. The rotational speed detection structure of the actuator according to claim 2, wherein a first annular support is detachably fixed on the encoder shaft; a second annular support surrounding the first annular support is detachably fixed on the shaft sleeve; a top surface of the first annular support forms the first mounting surface; and a top surface of the second annular support forms the second mounting surface.

13. The rotational speed detection structure of the actuator according to claim 12, wherein a downward-depressed first annular groove is formed in the top surface of the first annular support; a thickness of the first magnetic ring is the same as a depth of the downward-depressed first annular groove, and the first magnetic ring is nested in the downward-depressed first annular groove; a downward-depressed second annular groove is formed in the top surface of the second annular support; a thickness of the second magnetic ring is the same as a depth of the downward-depressed second annular groove, and the second magnetic ring is nested in the downward-depressed second annular groove; and an upper surface of the first magnetic ring is flush with an upper surface of the second magnetic ring.

14. The rotational speed detection structure of the actuator according to claim 12, wherein a fixed seat is sleeved on the encoder shaft; a set screw is threadedly connected to the fixed seat; an inner end of the set screw is inserted into a screw hole formed in the encoder shaft; and the first annular support is sleeved on the fixed seat and is in thread fit with the fixed seat.

15. The rotational speed detection structure of the actuator according to claim 12, wherein the second annular support is sleeved on a top of the shaft sleeve and is in thread fit with the shaft sleeve.

16. The rotational speed detection structure of the actuator according to claim 2, wherein the outer housing comprises an outer sidewall, a top wall extending inward along the radial direction of the actuator from a top of the outer sidewall, and a supporting wall extending downward from an inner edge of the top wall; a mounting space is formed between the supporting wall and the outer sidewall; the motor is disposed in the mounting space; the stator is fixedly connected to a periphery of the supporting wall; the rotor surrounds the stator; and the PCB is fixedly connected to the top wall, wherein the PCB is located above the first mounting surface and the second mounting surface.

17. The rotational speed detection structure of the actuator according to claim 16, wherein a mounting disc is fixedly connected on the top wall; an upward protruding annular convex rib is disposed on an upper surface of the mounting disc; and an outer edge of the PCB is circular and abuts against an inner edge of the upward protruding annular convex rib.

18. The rotational speed detection structure of the actuator according to claim 16, wherein the reducer mechanism is a harmonic reducer; a steel wheel of the harmonic reducer is fixedly fitted to the outer housing; a wave generator of the harmonic reducer is connected to a bottom of the rotor through a connecting bracket; an output flange pivotally connected to the outer housing through a first bearing is fixed on a flexible wheel of the harmonic reducer; a bottom of the encoder shaft is fixedly connected to the output flange; a fixed bracket is fixedly connected on the top wall; and a top of the encoder shaft is pivotally connected to the fixed bracket through a second bearing.

19. The rotational speed detection structure of the actuator according to claim 18, wherein a lower end of the shaft sleeve is fixedly connected to the connecting bracket through a bolt, wherein the shaft sleeve and the rotor are synchronously connected; and the shaft sleeve is located at an inner side of the supporting wall and pivotally fitted to the supporting wall through a third bearing.

20. An actuator, comprising: the rotational speed detection structure of the actuator according to claim 2.
